(19) United States
(12) Patent Application Publication
(10) Pub. No.: US 2025/0315073 A1
(43) Pub. Date: Oct. 9, 2025

(54) RADIALLY DECOUPLED DUAL INDUCTIVE POSITION SENSING ARRANGEMENT

(71) Applicant: CTS Corporation, Lisle, IL (US)

(72) Inventor: Micah Anderson, Mishawaka, IN (US)

(21) Appl. No.: 18/625,996

(22) Filed: Apr. 3, 2024

(51) Int. Cl. G05G 1/38; B60K 26/02; G05G 1/44

(52) U.S. Cl. CPC G05G 1/38; B60K 26/02; G05G 1/44

(57) ABSTRACT

A pedal assembly for a vehicle that includes a pedal housing; a rotatable pedal; a rotary inductive sensor target rotatable in response to movement of the rotatable pedal; and a rotary inductive position sensing arrangement. The rotary inductive position sensing arrangement includes: a printed circuit board (PCB); a first transmitter provided on the PCB and having a shape that surrounds a first portion of the PCB; a second transmitter provided on the first portion of the PCB surrounded by the first transmitter; and first and second receivers provided on the PCB between the first transmitter and the second transmitter. A rotation of the sensor target induces a change in a first electrical voltage of the first receiver and a change in a second electrical voltage of the second receiver. The rotary inductive position sensing arrangement can be used as a position sensor in traction motors or in other non-pedal applications.

### BACKGROUND

A vehicle pedal assembly includes a pedal housing, a rotatable pedal, and a position sensor. When the position sensor of the pedal is an inductive position sensor, the inductive position sensor includes an inductive sensor target rotatable in response to the rotation of the pedal and a substrate positioned opposite the inductive sensor target. Examples of vehicle pedal systems are disclosed in U.S. Pat. No. 11,614,765; and U.S. Patent Application 18/,047,174 filed Oct. 17, 2022, which are assigned to CTS Corporation.

### FIELD

Rotary inductive sensors may be used in a variety of applications. One application for rotary inductive sensors is sensing a position of a vehicle pedal, for example a brake pedal, an accelerator pedal, or another device.

### SUMMARY

Aspects of the present disclosure are directed to systems and methods for application for rotary inductive sensors in sensing a position of a vehicle pedal or other rotary device.

One example provides a pedal assembly for a vehicle comprising: a pedal housing, a rotatable pedal, a rotary inductive sensor target rotatable in response to movement of the rotatable pedal, and a rotary inductive position sensing arrangement. The rotary inductive position sensing arrangement includes: a printed circuit board (PCB) having a first side and a second opposing side; a first transmitter provided on the PCB and having a shape that surrounds a first portion of the PCB; a second transmitter provided on the first portion of the PCB surrounded by the first transmitter, the second transmitter having a shape that is disposed within the first portion of the PCB; and first and second receivers provided on the PCB between the first transmitter and the second transmitter. A rotation of the rotary inductive sensor target induces a change in a first electrical voltage of the first receiver and a change in a second electrical voltage of the second receiver.

Another example provides an inductive position sensing arrangement comprising: a printed circuit board (PCB) having a first side and a second opposing side; a first transmitter provided on the PCB and having a shape that surrounds a first portion of the PCB; a second transmitter provided on the first portion of the PCB surrounded by the first transmitter; and first and second receivers provided on the PCB between the first transmitter and the second transmitter. Rotation of an inductive sensor target induces a change in a first electrical voltage of the first receiver and a change in a second electrical voltage of the second receiver.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples, instances, and/or aspects of concepts that include the claimed subject matter, and explain various principles and advantages of examples, instances, and/or aspects.

FIG. 1 is a perspective view of a vehicle accelerator pedal incorporating an inductive position sensor assembly, according to one example.

FIG. 2 is an exploded perspective view of the vehicle accelerator pedal shown in FIG. 1.

FIG. 3 is a bottom view of the inductive position sensing arrangement, according to one example.

FIG. 4 is a top view of the inductive position sensing arrangement, according to the one example.

FIG. 5 is a perspective view of the inductive position sensing arrangement of FIGS. 3 and 4, with a cut-away view of the printed circuit board to show the transmitters and receivers.

FIG. 5A is a partial cut-away view of FIG. 5 showing a close up view of the transmitters and receivers.

FIG. 6 is a bottom view of a portion of another inductive position sensing arrangement that illustrates the transmitters and receivers.

FIG. 7 is a top view of a metal inductive sensor target.

FIG. 8 is a block diagram of an electronic controller that receives inputs from the inductive position sensing arrangement.

FIG. 9 is a top view of an example of an inductive position sensing arrangement based on FIG. 5 to show another arrangement of transmitters and individual receivers.

FIG. 10 is a top view of the example of FIG. 9 showing the transmitters and multiple receivers.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples.

The apparatus and method components have been represented where appropriate by conventional symbols in the drawings, showing only those specific details that are pertinent to understanding the examples, instances, and aspects illustrated so as not to obscure the disclosure with details that will be readily apparent to those of ordinary skill in the art having the benefit of the description herein.

### DETAILED DESCRIPTION

One or more aspects are described and illustrated in the following description and accompanying drawings. These aspects are not limited to the specific details provided herein and may be modified in various ways. Furthermore, other aspects may exist that are not described herein. For example, a device or structure that is “configured” in a certain way is configured in at least that way but may also be configured in ways that are not listed. Furthermore, some aspects described herein may include one or more electronic processors configured to perform the described functionality by executing instructions stored in non-transitory, computer-readable medium. Similarly, aspects described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, ROM (Read Only Memory), RAM (Random Access Memory), register memory, a processor cache, other memory and storage devices, or combinations thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms, for example, first and second, top and bottom, and the like may be used herein solely to distinguish one entity or action from another entity or action without necessarily requiring or implying any actual such relationship or order between such entities or actions.

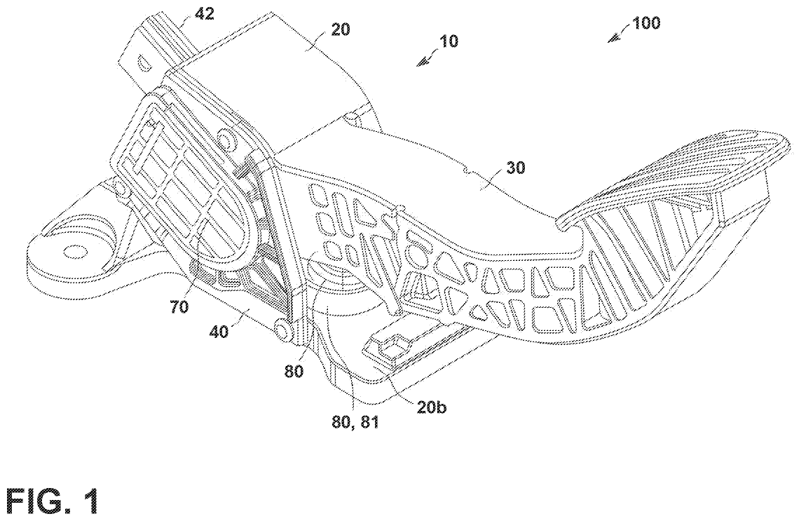

In FIG. 1, the vehicle accelerator pedal assembly 10 comprises a plastic pedal housing 20 including a plurality of exterior walls 20a and a base 20b together defining an interior 20c, a front opening 20d, and a side opening 20e.

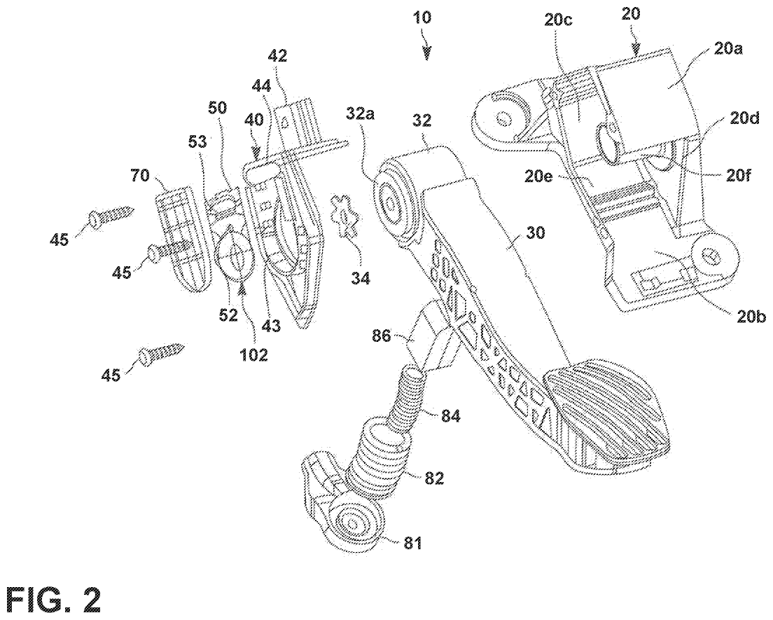

The vehicle accelerator pedal assembly 10 shown in FIGS. 1 and 2 also comprises an elongate plastic pedal arm 30 that includes a distal end or drum 32 with a metal inductive sensor target 34 adapted to be over-molded into the exterior side face 32a of the drum 32. The pedal arm 30 and, more specifically, the distal end or drum 32 with the target 34 thereon extends into the interior 20c of the pedal housing 20 into a relationship rotatable relative to the housing 20 and more specifically into a relationship surrounding and rotatable relative to a shaft 20f integral with one of the side exterior walls 20a of the housing 20 and extending into the interior 20c of the housing 20.

The accelerator pedal assembly 10 shown in FIGS. 1 and 2 further comprises a combination plastic housing cover 70 and electrical connector assembly 40 that is secured to the pedal housing 20 in a relationship covering and closing the housing side opening 20e and, more specifically, in a relationship covering the drum 32 of the pedal arm 30 located in the interior 20c of the housing 20 and, still more specifically, in a relationship opposed and spaced from the side exterior face 32a of the drum 32 of the pedal arm 30 with the inductive sensor target 34 over-molded therein. A plurality of screws 45 secure the electrical connector assembly 40 to the housing 20.

The electrical connector assembly 40 shown in FIGS. 1 and 2 includes an integral electrical connector 42 and defines both a central circular opening 43 and an interior recess 44 surrounding the opening 42. The electrical connector assembly 40 and the pedal arm 30 are positioned relative to each other in a relationship with the target 34 on the drum 32 of the pedal arm 30 extending into and located in the circular opening 43 defined in the electrical connector assembly 40 when a housing cover 70 is secured through the electrical connector assembly 40 to the housing 20.

The accelerator pedal assembly 10 still further includes a rotary inductive position sensing arrangement, inductive position sensor substrate or printed circuit board (PCB) 50 that includes opposed exterior faces 52 and 54 and which is insertable into and located and seated in the recess 44 defined in the electrical connector assembly 40 and positioned in a relationship opposed and adjacent the target 34 on the drum 32 of the pedal arm 30 and, still more specifically in the arrangement show, with the exterior face 54 of the substrate facing the target 34. A gap is provided between the sensor substrate 50 and the target 34, as a non-contacting arrangement is provided.

The sensor substrate 50 shown in FIG. 2 includes respective inductive sensor transmitter and receiver coil circuits defined and formed on the respective exterior top or front face 52 and the exterior bottom or back face 54 as described in more detail below. In one arrangement, the sensor substrate 50 includes four layers, and the inductive sensor transmitter and receiver coil circuits may also be defined on interior layers of the sensor substrate as well as exterior layers.

The accelerator pedal assembly 10 still further comprises a plastic electrical cover or plate 70 that covers the inductive substrate 50 and is secured to the exterior face of the electrical connector assembly 40.

The accelerator pedal assembly 10 additionally comprises a pedal friction assembly 80 located in the interior 20c of the housing 20. The pedal friction assembly 80 includes a friction device 81 seated on and adapted for pivotal movement relative to the base 22 of the pedal housing 20. A pair of telescoping springs 82 and 84 extend between the friction device 81 and the underside of the elongate pedal arm or pedal 30. A spring damper 86 is adapted to be wedged between the two springs 82 and 84.

The inductive position sensor assembly of the pedal assembly 10 in FIG. 2 comprises the combination of the inductive position sensor target 34 on the drum 32 of the pedal arm 30 and the substrate 50 and associated transmit and receiver coil circuits as described in more detail below.

The application or removal of a foot force to and from the pedal arm 30 during the operation of a vehicle (not shown) results in the movement/rotation of the rotatable pedal which in turn results in the movement/rotation of the pedal arm drum 32 in the interior 20c of the pedal housing 20 which results in the movement/rotation of the inductive sensor target 34 on the pedal arm drum 32.

The movement/rotation of the target 34 relative to the inductive position sensor transmitter and receiver coil circuits defined and formed on the exterior side faces 52 and 54 of the substrate 50 distorts the magnetic field generated by the respective transmit coil circuits of the inductive position sensor which results in a change in the voltage in the respective receiver coil circuits of the inductive position sensor.

The change in voltage is sensed and converted by the associated inductive position sensor integrated circuitry into an electrical signal output for sensing and measuring the position of the pedal arm 30 and in turn for controlling the acceleration and deceleration of the vehicle.

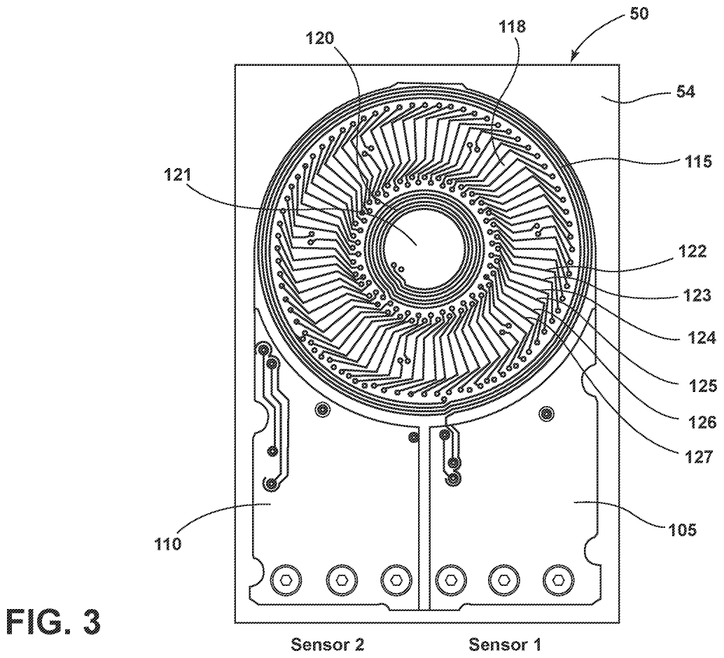

FIG. 3 depicts a bottom view of the inductive position sensing arrangement or substrate 50 that includes a first sensor 105 and a second sensor 110. The inductive position sensing arrangement 50 includes a first transmitter 115 extending in a shape about a first portion 118 of the sensing arrangement. The inductive position sensing arrangement 50 includes a second transmitter 120 that is located within the first portion 118 of the inductive position sensing arrangement 50 and surrounded by the shape of the first transmitter 115. The second transmitter 120 has a shape that includes an open second portion 121 of the circuit board 50 that is surrounded thereby.

The first transmitter 115 includes a transmitter coil having four turns in the arrangement shown in FIG. 3. In other examples, from one to twenty turns are contemplated. Multiple transmitter coils are also contemplated. In some examples, the transmitter coils represent traces that are formed by etching into the circuit board 50. The first transmitter 115 has a circular shape in FIG. 3 that surrounds completely the second transmitter 120. The first transmitter 115 provides a 360 degree transmission pattern.

The second transmitter 120 includes a transmitter coil having six turns in the sensing arrangement 50 shown in FIG. 3. In other examples, from one to twenty turns are contemplated. Multiple coils are also contemplated. In some examples, the second transmitter 120 is a coil formed by traces that are etched into the circuit board 50. The second transmitter 120 has a circular shape in FIG. 3 defining the second portion 121 therein. The second transmitter 120 provides a 360 degree transmission pattern.

FIG. 3 shows a plurality of receivers 122, 123, 124, 125, 126, 127, disposed or located between the first transmitter 115 and the second transmitter 120. The receivers 122-127 represent six receiver coils in one example. The receiver coils 122-127 have a generally symmetrical shape and extend in a shape about the entirety of the second transmitter 120. The shape represents a circular or undulating shape having a symmetrical pattern. Thus, the receiver coils 122-127 surround the second transmitter 120. The receivers 122-127 are 360-degree receivers surrounding entirely the second transmitter 120 in one example.

The receivers 122-127 include six receiver coils in the inductive position sensing arrangement 50 shown in FIG. 3. In other examples, from two to eight receivers are contemplated. Other numbers of receivers 122-127 are contemplated. In some examples, the receivers 122-127 represent coils formed by traces that are etched into the inductive position sensing arrangement 50. In one example, the receivers 22-127 are interleaved. In other examples, the receivers 122-127 of the two sensors only overlap slightly. In another example, the receivers 122-127 are formed by wire mounted onto the inductive position sensing arrangement 50.

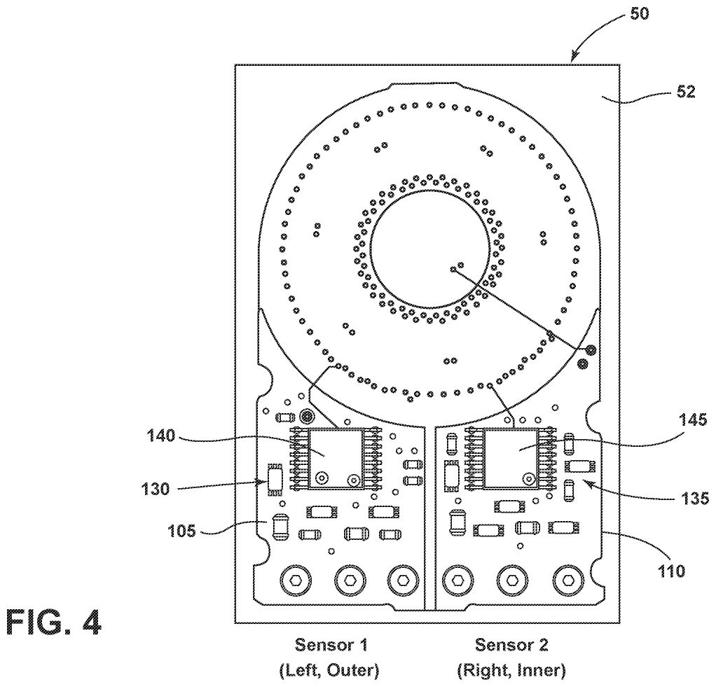

FIG. 4. shows a top view of the inductive position sensing arrangement 50 that includes the first sensor 105 that has a first sensor circuit 130 having various resisters, capacitors, a power source, and a first inductive position sensor interface 140. The first sensor circuit 130 transmits oscillating power or excitation current to the first transmitter 115 at a first frequency. The first transmitter 115 outputs electrical power that induces change in an electromagnetic field of the receivers 122-127 that is generated in response to a rotational movement of the target and the resulting current and/or voltage signal is provided to the first inductive position sensor interface 140. In one example, the first inductive position sensor interface 140 receives voltage input signals from three of the receivers 122, 124, 126 or three first receiver coils. The first inductive position sensor interface 140 processes the three received signals to provide a first sensor angle value. In one arrangement, the particular electrical properties (e.g., the voltage and/or current magnitude and polarity) is analyzed by the first inductive position sensor interface 140 to determine the first sensor angle value corresponding to a change in rotation position of the inductive sensor target 34.

FIG. 4 also shows the second sensor 110 that has a second sensor circuit 135 having various resisters, capacitors, a power source, and a second inductive position sensor interface 145. The second sensor circuit 135 transmits oscillating power/excitation current to the second transmitter 120 at a second frequency. The second transmitter 120 outputs electrical power that induces change in an electromagnetic field of the inductive receivers 123, 125, 127 that is generated in response to a rotational movement of the sensor target 34 and the resulting current and/or voltage signal is provided to the second inductive position sensor interface 145. In one example, the second inductive position sensor interface 145 receives voltage signals from three of the receivers 123, 125, 127 or three receiver coils. The second inductive position sensor interface 145 processes the three received signals to provide a second sensor angle value. In one arrangement, the particular electrical properties (e.g., the voltage and/or current magnitude and polarity) is analyzed by the second inductive position sensor interface 145 to determine the second sensor angle value corresponding to a change in rotation position of the inductive sensor target 34. In one example, the three receivers 122-127 of the two sensors are arranged in a star configuration, which includes one end of each receiver including a coil tied or joined together. The first sensor circuit 130 and the second sensor circuit 135 measure the differential voltages induced in the receivers 122-127 between each of the combinations of two pins of the star configuration. The differential voltages are used by the first sensor circuit 130 and the second sensor circuit 135 to calculate the position/angle of the metal inductive sensor target 34.

The frequency to drive the first transmitter 115 and the second transmitter 120 is between 2 and 5 Megahertz (MHz) and preferably between 3 MHz and 4 MHz. In one example, the frequencies are 3.2 MHz and 3.8 MHz. In another example, the frequencies are 3.3 MHz and 3.7 MHz. Other frequency ranges and frequency values are contemplated. The first transmitter 115 and the second transmitter 120 have a distinct and different frequency in the examples.

The first transmitter 115 and the second transmitter 120 are a distance apart from each other to provide geometric isolation. If one transmitter is shorted to ground, such as through a failed capacitor, the sensor of the other transmitter will continue to function and measure the angle of the rotary inductive sensor target 34 with respect to the inductive position sensing arrangement 50.

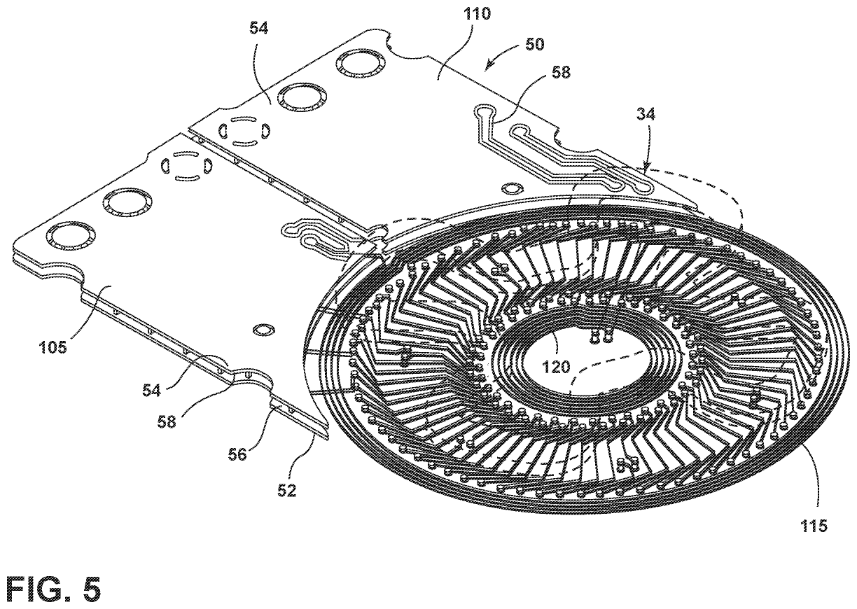

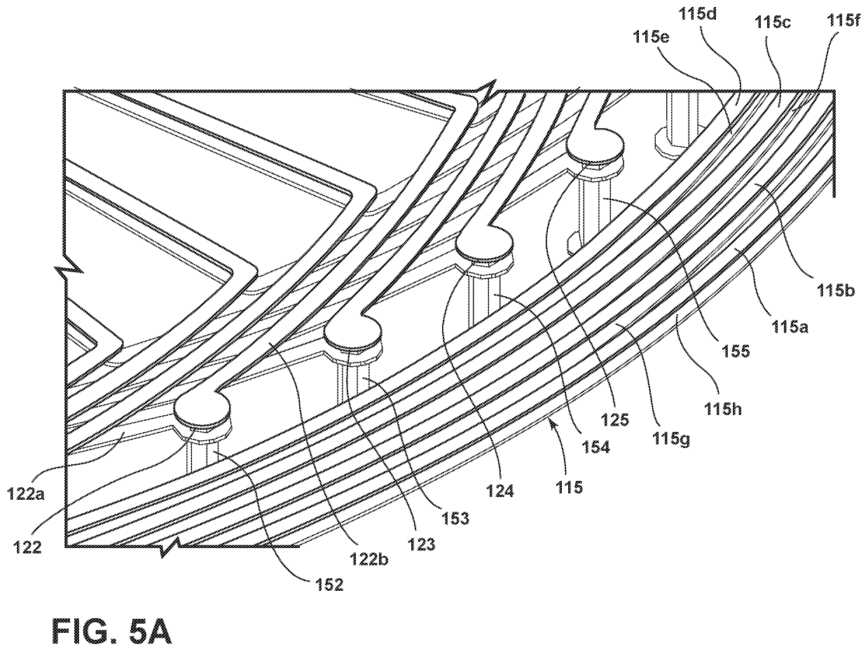

FIG. 5 shows a perspective view of the printed circuit board 50, with the dielectric removed to better illustrate the pattern of the first transmitter 115, the second transmitter 120, and the receivers 122-127. As shown in FIG. 3, in one example, the transmitters 115, 120, and the receivers 122-127 are disposed on a bottom side of the printed circuit board 50. FIG. 5 also shows how the printed circuit board 50 includes four layers of material. In one example the material is copper with layers of dielectric material therebetween. The exterior front face 52 represents a first outer layer and the exterior back face 54 represents a second outer layer on an opposing side. Two middle layers 56, 58 are also shown in FIG. 5. Middle layer 56 is adjacent front face 52. Middle layer 58 is shown as etched areas in the back face 54 or layer shown in FIG. 5. FIG. 5 shows another shape for the inductive sensor target 34.

FIG. 5A shows a perspective view of a portion of the transmitter 115 and the receivers 122-125 (other receivers are not shown). The transmitter 115 is defined by eight turns 115a-115h of a transmitter coil. The turns 115a-115d represent four turns corresponding to the perspective view shown in FIG. 5. The turns 115e-115h represent another layer of turns of the transmitter 115 disposed near turns 115a-115d, respectively. The turns 115a-115d are separated from the turns 115e-115h by a gap or space of dielectric material.

The receivers 122-125 shown in the partial view of FIG. 5A are secured to vias 152-155, respectively. In one example, the receiver 122 includes a first receiver trace 122a oriented leftwardly from the via 152 in FIG. 5A and a second receiver trace 122b oriented rightwardly from the via 152. The first trace 122a and the second trace 122b form a pattern extending about the entirety of the second transmitter 120 to form a 360 degree receiver 122. The other receivers 123-125 and vias 153-155 shown in FIG. 5A include similar arrangements.

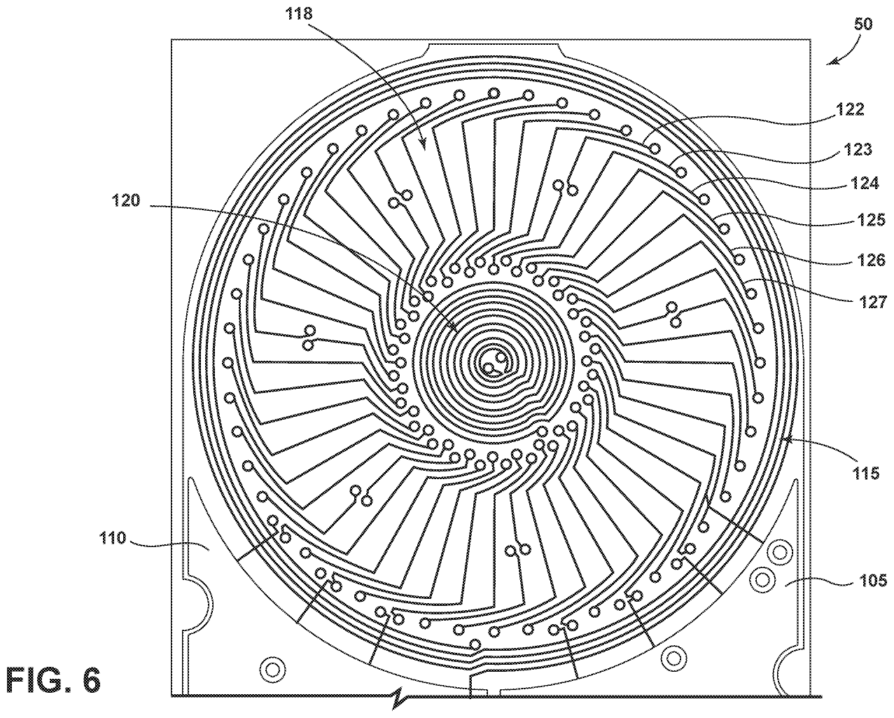

FIG. 6 shows another example of an inductive position sensing arrangement 50 having transmitters 115, 120 and receivers 122-127. The FIG. 6 arrangement is similar to the FIG. 3 arrangement, except there is no second portion 121 surrounded by the second transmitter 120. Instead, the second transmitter 120 shown in FIG. 6 is a transmitter having ten or more transmitter turns extending from a center of the first portion 118 of the printed circuit board (PCB). Thus, the second transmitter 120 is essentially symmetrically placed in a center of the first portion 118 that is surrounded by the first transmitter 115. Thus, in this example, the second portion 121 is not present as the second transmitter 120 includes start at the center of the first portion 118 defined by the first transmitter 115 of the inductive position sensing arrangement 50. In FIG. 6, the first transmitter 115 includes four transmitter turns. However, other numbers of transmitter coils having turns and/or traces are contemplated.

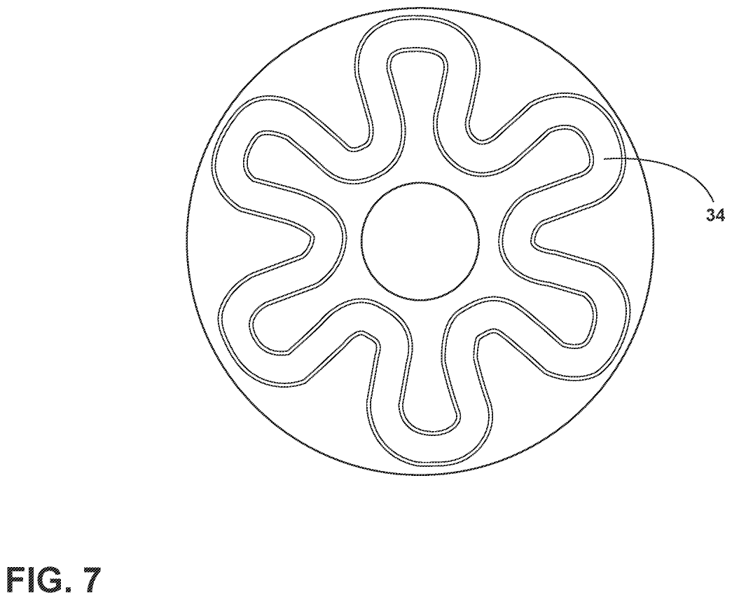

FIG. 7 shows a top view of a metal inductive sensor target 34. In one example, the metal inductive sensor target 34 is a milled copper target. Other arrangements are contemplated.

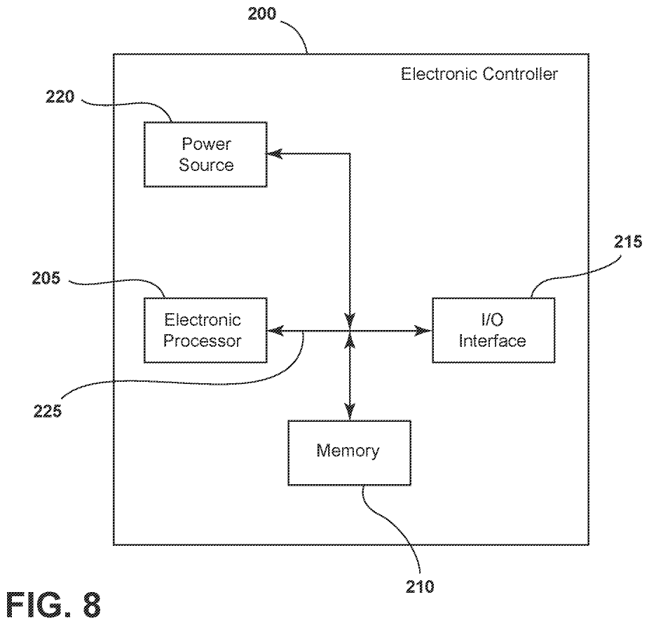

FIG. 8 schematically illustrates one example of an electronic controller 200. In the example illustrated, the electronic controller 200 includes an electronic processor 205, a memory 210, an input/output interface 215, and a power source 220. The illustrated components, along with other various modules and components are connected to each other by or through one or more control or data buses (for example, the bus 225) that enable communication therebetween. The electronic controller 200 may be housed in a single device (for example, an application-specific integrated circuit (ASIC)) or distributed across a plurality of devices.

The electronic processor 205 shown in FIG. 8 may include one or more microprocessors, an ASIC, or another suitable electronic device. The electronic processor 205 obtains and provides information (e.g., to and from the memory 210 and/or the input/output interface 215) and processes the information by executing one or more software instructions or modules, capable of being stored, for example, in a random access memory (“RAM”) area of the memory 210, a read only memory (“ROM”) of the memory 210, or another non-transitory computer readable medium (not shown). The software can include firmware, one or more applications, program data, filters, rules, one or more program modules, and other executable instructions. The electronic processor 205 is configured to retrieve from the memory 210 and execute, among other things, software related to processes and methods described herein.

The electronic processor 205 is configured to control the input/output interface 215 to transmit and receive communication and/or power signals (for example, via one or more switches, which are not shown) to and from at least one other device (for example, the first sensor 105 and the second sensor 110 of the inductive position sensing arrangement 50 shown in FIGS. 3-6). The input/output interface 215 may include various digital and analog components (for example, digital signal processors, high band filters, low band filters, and the like), which for brevity are not described herein and which may be implemented in hardware, software, or a combination of both. The input/output interface 215 may include, for example, a transceiver, a transmitter, and/or a receiver (not shown). The input/output interface 215 may alternatively or additionally include one or more ports for wired communications with respective components (for example, the first sensor 105 and the second sensor 110). In some arrangements, the electronic processor 205 is configured to provide current (from the power source 220) to power the transmitters 115, 120 of the inductive position sensing arrangement 50. The power source 220 may be part of the electronic controller 200 itself or is a separate source from one or more electrical systems of the vehicle.

### Operation

In operation, electrical power is provided to the inductive position sensing arrangement 50 from a power source (for example, the power source 220 that is connected to or is part of the electronic controller 200 shown in FIG. 8), that provides current or power to the first transmitter 115 and the second transmitter 120 of the inductive position sensing arrangement 50. Other power sources are contemplated.

The transmitters 115, 120 include a transmitter coil having turns and/or traces. The first transmitter 115 transmits current or power at a first frequency, such as 3.3 MHz, while the second transmitter 120 transmits current or power at a second frequency, such as 3.7 MHz in one example. The current flows through the transmitting coil having turns and/or traces and also generates a magnetic field around the coils of the respective transmitters 115, 120.

The application or removal of a force to and from the pedal arm 30 (for example, from a foot of a user) during the operation of a vehicle (not shown) results in the movement/rotation of the pedal arm 30 which in turn results in the movement/rotation of the pedal arm drum 32 in the interior 20C of the pedal housing 20 which results in the movement/rotation of the rotary inductive sensor target 34 relative to the receivers 122-127.

The receivers 122-127 also include a plurality of receiver coils having turns and/or traces that are positioned such that the magnetic field generated by the transmitters 115, 120 induces a voltage or current within the receiving coils. The electrical voltage signal induced in the receiving coils of the receivers 122, 124, 126 are provided as voltage input signals to the first inductive position sensor interface 140 of the first sensor circuit 130. The voltage and polarity are analyzed by the first inductive position sensor interface 140 to determine a first sensor angle value corresponding to a change in rotation position of the inductive sensor target 34.

Likewise, the magnetic field generated by the second transmitter 120 induces a voltage or current in the receiving coil having turns and/or traces of the receivers 123, 125, 127 that are provided as voltage input signals to the second inductive position sensor interface 145 of the second sensor circuit 135. The voltage and the polarity are analyzed by the second inductive position sensor interface 145 to determine a second sensor angle value corresponding to a change in rotation position of the inductive sensor target 34.

The first sensor angle value is provided from the first sensor circuit 130 via the input/output interface 215 of the electronic controller 200 to the electronic processor 205. Likewise, the second sensor angle value is provided from the second sensor circuit 135 via the input/output interface 215 of the electronic controller 200 to the electronic processor 205.

The movement/rotation of the rotary inductive sensor target 34 relative to the inductive position sensing arrangement 50, and namely the transmitters 115, 120 and the receivers 122-127 of the inductive position sensing arrangement 50 results in a change in the magnetic field detected by the respective receivers 122-127 of the inductive position sensing arrangement 50. The resulting change in the electrical or voltage signal provided to the electronic controller 200 is then utilized by the electronic controller 200 to determine a position of the pedal arm 30 and accordingly control one or more operations of the vehicle (for example, the acceleration and deceleration of the vehicle).

In some arrangements, the electronic controller 200 is configured to operate and receive signals from the inductive position sensing arrangement 50. Based on the received signals, as described above, the controller 200 determines a position, a speed, and/or a change in position of the rotary inductive sensor target 34 (and, thus, of the pedal arm 30). The electronic controller 200, in one example, provides the derived information to one or more controllers of the vehicle. The one or more controllers accordingly control one or more operations of the vehicle (for example, the vehicle acceleration and deceleration of the vehicle) based on the received information. In some arrangements, some or all of the functionality of the electronic controller 200 is integrated into a vehicle control unit (VCU) of the vehicle. The controller 200 may communicate information (for example, the determined position, speed, and/or change in position determined from a signal from the inductive position sensing arrangement 50 to a VCU or another controller of the vehicle to perform an operation of the vehicle based on the derived information. In some arrangements, some or all of the functionality of the electronic controller 200 is integrated into the inductive position sensing arrangement 50. In some arrangements, some or all of the processing of the signals generated by the inductive position sensing arrangement 50 may be performed at the electronic controller 200. In some arrangements, the inductive position sensing arrangement 50 may include circuitry components such as a microprocessor and memory (not shown) for performing at least a portion of processing of the generated signals.

### Additional Examples

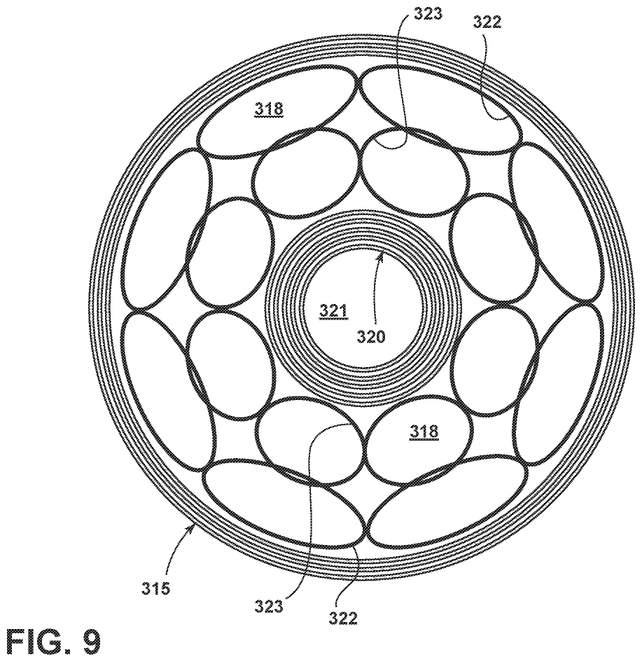

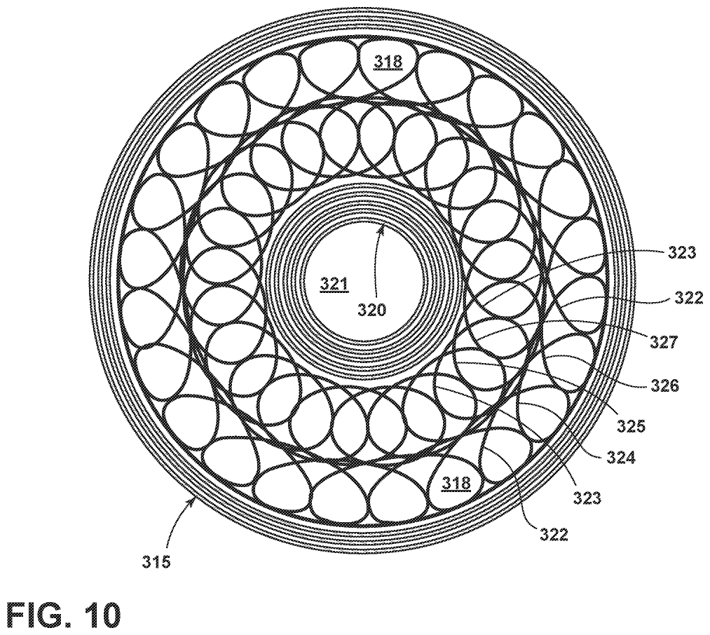

FIG. 9 shows another example of transmitters and receivers for an inductive position sensing arrangement wherein the dielectric of the PC board is not shown for purposes of illustration. FIGS. 9 and 10 are provided to illustrate an example of the locations of receivers of a position sensing arrangement. More specifically, FIG. 9 shows a first transmitter 315 having three turns and disposed about a second transmitter 320 represented as having five turns. Other numbers of turns for the first transmitter 315 and the second transmitter 320 are contemplated. A first portion 318 is provided between the first transmitter 315 and the second transmitter 320 provided on the PC board (not shown). A second portion 321 of the PC board is provided within the circular shaped second transmitter 320. A receiver 322 is provided near an inner periphery of the first transmitter 315. The receiver 322 is a 360 degree receiver. A receiver 323 is provided between the receiver 322 and the second transmitter 320. The receiver 323 is a 360 degree receiver surrounding the entirety of the second transmitter 320. FIG. 9 is provided to better illustrate an example of receivers that interact with respective transmitters. The receiver 322 receives energy from the first transmitter 315 that is affected by the position of the metal inductive sensor target 34. The receiver 323 receives energy from the second transmitter 320 that is affected by the position of the metal inductive sensor target 34.

FIG. 10 shows the arrangement of FIG. 9 with additional receivers to measure different phases. Receivers 322, 324, 326 are provided to sense the position of the metal inductive sensor target 34 from the energy provided by the first transmitter 315. Second receivers 323, 325, 327 are provided to sense the position of the metal inductive sensor target 34 from the energy provided by the second transmitter 320. The signals are provided to respective inductive position sensor interfaces and processed as discussed above and shown in FIG. 4 to determine sensor angle values corresponding to a change in rotation position of the inductive sensor target 34.

While the inductive position sensing arrangement 50 is disclosed as sensing movement of a pedal, other arrangements are contemplated including sensing the position of a traction motor or other devices.

In the foregoing specification, specific examples have been described. However, one of ordinary skill in the art appreciates that various modifications and changes may be made without departing from the scope of the arrangement as set forth in the claims below. Accordingly, the specification and figures are to be regarded in an illustrative rather than a restrictive sense, and all such modifications are intended to be included within the scope of present teachings.

Also, the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if arrangements described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

The benefits, advantages, solutions to problems, and any element(s) that may cause any benefit, advantage, or solution to occur or become more pronounced are not to be construed as a critical, required, or essential features or elements of any or all the claims. The arrangement is defined solely by the appended claims including any amendments made during the pendency of this application and all equivalents of those claims as issued.

In addition, unless the context of their usage unambiguously indicates otherwise, the articles “a” and “an” should not be interpreted as meaning “one” or “only one.” Rather these articles should be interpreted as meaning “at least one” or “one or more”. Likewise, when the terms “the” or “said” are used to refer to a noun previously introduced by the indefinite article “a” or “an,” “the” and “said” mean “at least one” or “one or more” unless the usage unambiguously indicates otherwise.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A pedal assembly for a vehicle comprising:
a pedal housing;
a rotatable pedal;
a rotary inductive sensor target rotatable in response to movement of the rotatable pedal; and
a rotary inductive position sensing arrangement including:
a printed circuit board (PCB) having a first side and a second opposing side;
a first transmitter provided on the PCB and having a shape that surrounds a first portion of the PCB;
a second transmitter provided on the first portion of the PCB surrounded by the first transmitter, the second transmitter having a shape that is disposed within the first portion of the PCB; and
first and second receivers provided on the PCB between the first transmitter and the second transmitter,
wherein a rotation of the rotary inductive sensor target induces a change in a first electrical voltage of the first receiver and a change in a second electrical voltage of the second receiver.

2. The pedal assembly of claim 1, wherein first transmitter includes a first transmitter coil having a circular shape that surrounds the first and second receivers and the second transmitter.

3. The pedal assembly of claim 2, wherein the second transmitter includes a second transmitter coil having a circular shape, the second transmitter coil being surrounded by the first transmitter coil.

4. The pedal assembly of claim 3, wherein the second transmitter coil includes a trace formed by etching.

5. The pedal assembly of claim 1, wherein the first transmitter transmits at a first frequency and the second transmitter transmits at a second frequency that is different from the first frequency.

6. The pedal assembly of claim 1, wherein the first receiver includes a plurality of turns provided in a symmetrical pattern surrounding the second transmitter.

7. The pedal assembly of claim 6, wherein the second receiver includes a plurality of turns provided in a symmetrical pattern surrounding the second transmitter.

8. The pedal assembly of claim 7, wherein the first receiver includes three first receiver coils and the second receiver includes three second receiver coils, and wherein the three first receiver coils and the three second receiver coils are interleaved and surround the second transmitter.

9. The pedal assembly of claim 8, including a first sensor circuit including a first inductive position sensor interface to receive voltage signals from the three first receiver coils and output a first sensor angle value.

10. The pedal assembly of claim 9, including a second sensor circuit including a second inductive position sensor interface to receive voltage signals from the three second receiver coils and output a second sensor angle value.

11. The pedal assembly of claim 10, wherein the first sensor circuit provides an excitation current to the first transmitter and the second sensor circuit provides an excitation current to the second transmitter.

12. An inductive position sensing arrangement comprising:
a printed circuit board (PCB) having a first side and a second opposing side;
a first transmitter provided on the PCB and having a shape that surrounds a first portion of the PCB;
a second transmitter provided on the first portion of the PCB and surrounded by the first transmitter; and
first and second receivers provided on the PCB between the first transmitter and the second transmitter,
wherein a rotation of an inductive sensor target induces a change in a first electrical voltage of the first receiver and a change in a second electrical voltage of the second receiver.

13. The inductive position sensing arrangement of claim 12, wherein the first transmitter includes a first transmitter coil having a circular shape that surrounds the first and second receivers and the second transmitter.

14. The inductive position sensing arrangement of claim 13, wherein the second transmitter includes a second transmitter coil having a circular shape, the second transmitter coil being surrounded by the first transmitter coil, the second transmitter coil having a shape that surrounds a second portion of the PCB that is within the first portion of the PCB.

15. The inductive position sensing arrangement of claim 14, wherein the second transmitter coil includes a trace formed by etching.

16. The inductive position sensing arrangement of claim 12, wherein the first transmitter transmits at a first frequency and the second transmitter transmits at a second frequency that is different from the first frequency.

17. The inductive position sensing arrangement of claim 12, wherein the first receiver includes a plurality of turns provided in a symmetrical pattern surrounding the second transmitter.

18. The inductive position sensing arrangement of claim 17, wherein the second receiver includes a plurality of turns provided in a symmetrical pattern surrounding the second transmitter.

19. The inductive position sensing arrangement of claim 18, wherein the first receiver includes three first receiver coils and the second receiver includes three second receiver coils, and wherein the three first receiver coils and the three second receiver coils are interleaved,
the inductive position sensing arrangement including a first sensor circuit having a first inductive position sensor interface to receive voltage signals from the three first receiver coils and output a first sensor angle value, and
wherein an input/output interface of an electronic controller receives the first sensor angle value and the electronic controller is configured to control vehicle acceleration or deceleration.

20. The pedal assembly of claim 1, wherein the first transmitter and the second transmitter are a distance apart from each other to provide geometric isolation.
